(19) United States
(12) Patent Application Publication
(10) Pub. No.: US 2024/0337614 A1
(43) Pub. Date: Oct. 10, 2024

(54) MICROFLUIDIC CELL FABRICATION INCLUDING ATOMIC LAYER DEPOSITION (ALD) OF CALCITE LAYER FOR EIOR STUDIES

(71) Applicant: SAUDI ARABIAN OIL COMPANY, Dhahran (SA)

(72) Inventors: Ghaida Ahmed ALJUHANI, Dammam (SA); Dongkyu CHA, Dhahran (SA); Subhash C. AYIRALA, Dhahran (SA); Abdulaziz S. AL-QASIM, Dhahran (SA); Ali Abdallah AL-YOUSEF, Dhahran (SA)

(73) Assignee: SAUDI ARABIAN OIL COMPANY, Dhahran (SA)

(21) Appl. No.: 18/295,657

(22) Filed: Apr. 4, 2023

(51) Int. Cl. E21B 43/24; B01L 3/00; E21B 49/08

(52) U.S. Cl. CPC G01N 27/06; B01L 3/502707; B01L 3/502715; B01L 2300/0861; B01L 2300/12; B01L 2400/0496

(57) ABSTRACT

A method for demonstrating the efficacy of using electrical current in an Electrical Improved Oil Recovery (EIOR) application includes circulating fluid through a microfluidics cell having first and second electrodes, applying a voltage across the first and second electrodes, determining the behavior of the fluid under the effect of the applied voltage, and correlating the determined behavior to a reservoir of interest. The method may include deriving operational parameters from the correlation and operating the reservoir of interest in accordance with the operational parameters, and may include visualization and characterization of enlarging pore throat for enhancing permeability and oil mobilization.

### FIELD OF THE DISCLOSURE

The present disclosure relates generally to devices for the simulation and observation of fluid behavior, and particularly for Electrical Improved Oil Recovery (EIOR).

### BACKGROUND OF THE DISCLOSURE

One of the most prominent and innovative oil recovery methods utilizes the low carbon footprint Electrical Improved Oil Recovery (EIOR) technology. It is applied for the enhancement of injectivity and productivity through the application of electrical current between well pairs.

One basic function of the EIOR process is to increase the mobility of the oil, for example by reducing its viscosity, helping the oil to more easily move towards the production well. One reason for this is that the electrical energy supplied to the reservoir will either raise the temperature of the oil or create vibrations in the hydrocarbon molecules.

Based on the frequency of electrical current being used, the electric heating methods can be divided into three main categories. Low-frequency electric current is best suited for ohmic or resistive heating, while high-frequency electric current can be used for microwave heating methods. For inductive heating, a range of low- and medium-frequency electric currents can be used depending on the energy availability.

EIOR technology can provide several advantages such as removal of pore throat blockage, increased permeability, and water cut reduction. In inter-granular rock, pore throat is the small pore space at the point where two grains meet, which connects two larger pore volumes. The number, size and distribution of pore throats control many of the resistivity, flow and capillary-pressure characteristics of the rock. Pore-throat size determines the oil and gas occurrence and storage properties of sandstones for instance and is a vital parameter to evaluate reservoir quality.

During oil production, formation damage can be caused by fines migration. An example of fines migration is the internal movement of fine particulates in a pore structure to cause bridging and plugging of pore throats. When fines are moving through a porous medium, they are often deposited in the pore throats, causing a severe reduction in permeability. Different physical and chemical mechanisms contribute to fines migration, including temperature, salinity, pH change and flow rates.

There is a long-felt need for demonstrative lab analyses and tools to better elucidate the mechanisms by which electric current, for example as deployed in EIOR, can influence the aforementioned parameters and behaviors, particularly in connection with pore throat blockage. The ability to study the alteration in permeability and enlargement of pore throat radius as a function of the strength of electric current being applied, would help meet this need, and help determine, for a specific field or reservoir, the ideal electrical current range that should be applied.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method for demonstrating the efficacy of using electrical current in an Electrical Improved Oil Recovery (EIOR) application includes circulating fluid through a microfluidics cell having first and second electrodes, applying a voltage across the first and second electrodes, determining the behavior of the fluid under the effect of the applied voltage, and correlating the determined behavior to a reservoir of interest.

In certain embodiments, the method includes deriving operational parameters from the correlation and operating the reservoir of interest in accordance with the operational parameters.

In certain embodiments, the method includes visualization and characterization of enlarging pore throat for enhancing permeability and oil mobilization.

In another embodiment, a method for fabricating a microfluidics cell includes applying a photoresist layer on a silicon substrate, removing a first portion of the photoresist layer, applying a pair of electrodes at the removed first portion, removing a second portion of the photoresist to form a predetermined pattern, etching the silicon substrate based on the predetermined pattern to form an etched portion of the silicon substrate, removing a third portion of the photoresist layer to thereby form an exposed portion of the silicon substrate, and depositing calcite on the etched and exposed portions of the silicon substrate.

In a further embodiment, a device includes a silicon substrate, a calcite layer formed on the silicon substrate and having fluid channels for entrainment of fluid therein, and first and second electrodes for introducing electrical potential across the fluid channels and for analyzing electrical characteristics as a function of the electrical potential due to entrainment of fluid in the fluid channels.

In certain embodiments, the device further includes an observation window for observing an effect of the electrical potential on the fluid and/or channels.

In certain embodiments, the device further includes inlet and outlet ports in communication with the fluid channels.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram showing an EIOR testing system 100 in accordance with certain embodiments.

FIG. 1A is a top view of microfluidics cell depicting the action of brine in the cell during a test run whereby an electric potential is applied as fluid is circulated in the micro channels of the cell.

FIG. 2 is a schematic diagram showing the process flow of a method for the fabrication of a calcite microfluidics cell for use in EIOR technology testing and analysis in accordance with certain embodiment.

FIG. 3 is a flow diagram showing a method for analyzing and demonstrating the efficacy of using electrical current in an EIOR application using the system 100 in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to systems and devices for the simulation and observation of fluid behavior, and particularly for EIOR studies.

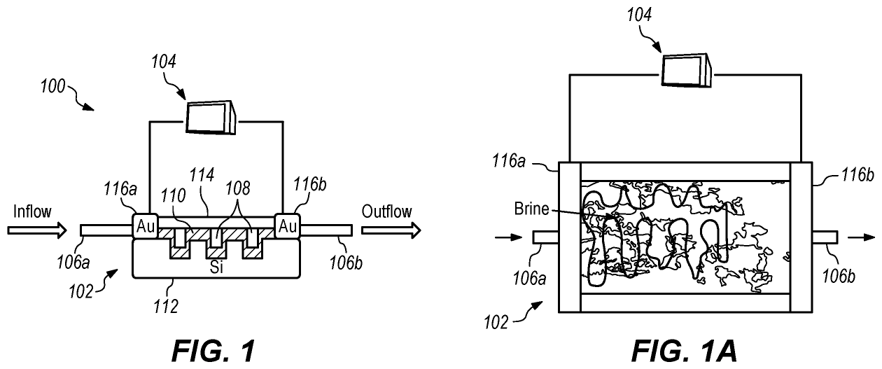

FIG. 1 is a block diagram showing an EIOR testing system 100 in accordance with certain embodiments. EIOR testing system 100 comprises a calcite microfluidics cell 102 couplable to a parameter analyzer 104, such as for analyzing electrical characteristics and behavior in connection with fluid flow in the microfluidics cell. Microfluidics cell 102 includes an inlet port 106a and an outlet port 106b that are in fluid communication with fluid channels 108 formed in a calcite layer 110 on a silicon substrate 112. The channels, in which fluid such as brine is entrained, as detailed below, are bound by a glass cover 114. The glass cover facilitates 114 observation of the entrained fluid and the effect of an electrical potential applied across the channels and fluid by way of electrodes 116a, 116b.

In operation, fluid such as brine is introduced into the channels 108 of cell 102 through the inlet port 106a and expelled through the outlet port 106b, while the parameter analyzer 104, electrically coupled across the cell by way of the electrodes 116a,b, measures parameters such as resistivity and conductivity, current magnitude, voltage potential, etc., for example as a function of fluid flow rate, pressure, temperature, and fluid chemistry such as salinity, and the like. An example parameter analyzer for use in system 100 is a Keithly 4200™ I-V analyzer.

Microfluidics cell 102 is configured to enable observation of the behavior of the entrained fluid (e.g. brine), including for example visualization and characterization of enlarging pore throat for enhancing permeability and oil mobilization with the application of electric current, thereby providing a high quality visual representation capturing a precise physical change of pore throat and oil flow and the concomitant fluid behavior. FIG. 1A for example shows a top view of microfluidics cell 102 and depicts the action of brine in the cell during a test run whereby an electric potential is applied by way of electrodes 116 as fluid is circulated in the micro channels 108. Unlike conventional techniques, which are incapable of verifying the drastic alteration and modification to oil flow e.g., and the variation in the size of the pore throat during EIOR, the system 100 enables studying these phenomena and determining the precise voltage that should be applied for EIOR in a specific carbonate reservoir. It will be appreciated that the description of the application of electrical forces in the testing regimes described herein may be expressed in terms voltage, current, potential, or power, as these are interrelated in a well understood manner.

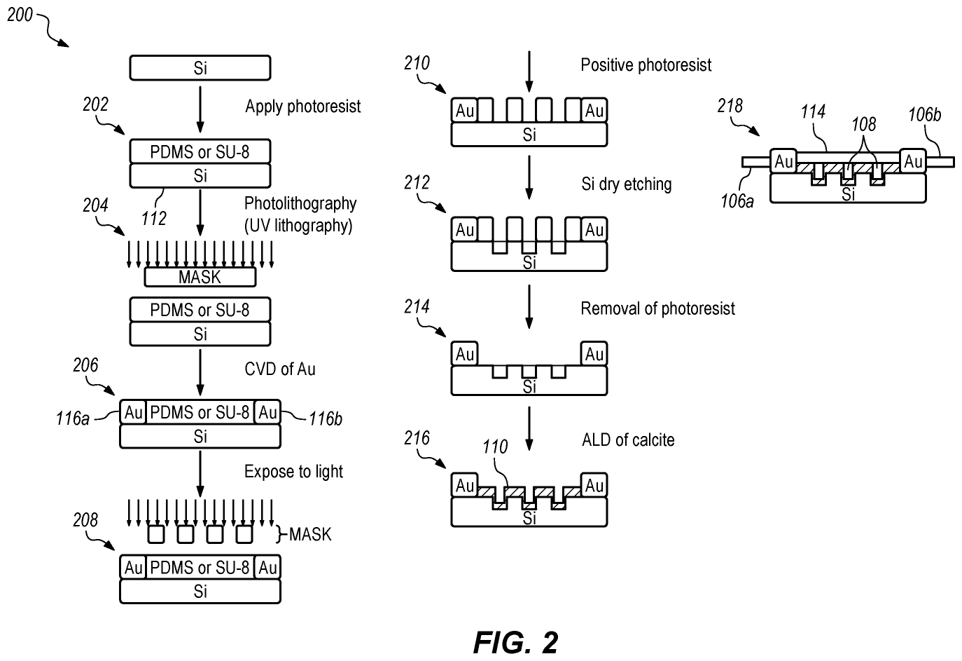

FIG. 2 is a schematic diagram showing the process flow of a method 200 for the fabrication of a calcite microfluidics cell, such as cell 100 (FIG. 1), for use in EIOR technology testing and analysis in accordance with certain embodiments. At 202, a PDMS (polydimethylsiloxane) or SU-8 layer is applied as a photoresist layer on a silicon (Si) substrate (e.g. 112, FIG. 1) and a bake out is performed. PDMS is an elastomeric silicone material that is widely used for rapid prototyping microfluidic systems and cell-chip devices, due to features such as its chemical inertia, thermal stability, permeability to many gases, simple preparation, optical transparency, and low cost.

At 204, portions of the PDMS or SU-8 are removed, for example by masking and applying photolithographic techniques, such as UV lithography.

At 206, electrode (e.g. anode and cathode) coating is performed. The electrodes (e.g. 116a,b, FIG. 1) are formed in the removed portions of the PDMS or SU-8. A candidate material for the electrodes, which may be coated by chemical vapor deposition (CVD), is gold due to its inertness to the anticipated chemical environment in system 100, and its good electrical conductivity characteristics.

At 208, a patterned mask is applied over the remaining PDMS or SU-8 material, with the patterns corresponding to the desired microfluidic channels of the finished cell. Light-exposed portions can be removed at 210 by a positive photoresist step.

Silicon dry etching can then be performed at 212 to remove portions of the silicon substrate, consistent with the desired microfluidic channel pattern.

At 214 the photoresist layer of PDMS or SU-8 is removed.

At 216, a calcite coating (e.g. 110, FIG. 1) is applied, for example by atomic layer deposition (ALD), to complete the profile of the microfluidics channel.

At 218, a glass cover (e.g. 114, FIG. 1), and inflow (e.g. 106a, FIG. 1) and outflow (e.g. 106b, FIG. 1) conduits in fluid communication with the formed microfluidic channels (e.g. 108, FIG. 1), are attached.

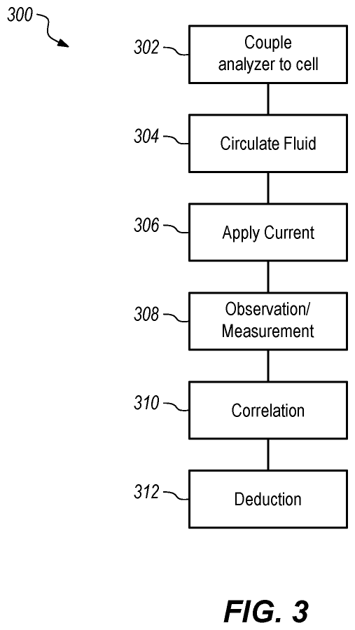

FIG. 3 is a flow diagram showing a method 300 for analyzing and demonstrating the efficacy of using electrical current in an EIOR application using the system 100 (FIG. 1) in accordance with certain embodiments. At 302, a parameter analyzer (e.g. 104, FIG. 1), such as a Keithly 4200™ I-V analyzer, is electrically coupled to a microfluidics cell (e.g. 102, FIG. 1) by way of electrodes (e.g. 116a, 116b, FIG. 1). At 304, fluid, such as brine, is circulated in the microfluidics cell and at 306, current and/or voltage is applied across the electrodes of the cell by the parameter analyzer. The application of current/and voltage can be in accordance with a testing regimen that can cycle through various voltage/current/power values, frequencies, etc. and that may be correlatable to a specific carbonate reservoir of interest. At 308, the behavior of the fluid and the cell, including the channels thereof, are observed, for example visually through the glass window (e.g. 114, FIG. 1) of the cell, and empirically through measurements made by the parameter analyzer. At 310, the observations and measurements are correlated to the particular reservoir of interest, and to features such as enlarging pore throat for enhancing permeability and oil mobilization; and, at 312, optimal in EIOR operational parameters for that reservoir are deduced. The operational parameters can be used for exploration and/or drilling and/or further operations at the reservoir of interest.

### ADDITIONAL EMBODIMENTS

The present disclosure is also directed to the following exemplary embodiments, which can be practiced in any combination thereof:

Embodiment 1: A method for demonstrating the efficacy of using electrical current in an Electrical Improved Oil Recovery (EIOR) application includes circulating fluid through a microfluidics cell having first and second electrodes, applying a voltage across the first and second electrodes, determining the behavior of the fluid under the effect of the applied voltage, and correlating the determined behavior to a reservoir of interest.

Embodiment 2: The method of embodiment 1, further comprising deriving operational parameters from the correlation and operating the reservoir of interest in accordance with the operational parameters.

Embodiment 3: The method of embodiments 1 or 2 further comprising visualization and characterization of enlarging pore throat for enhancing permeability and oil mobilization.

Embodiment 4: A method for fabricating a microfluidics cell includes applying a photoresist layer on a silicon substrate, removing a first portion of the photoresist layer, applying a pair of electrodes at the removed first portion, removing a second portion of the photoresist to form a predetermined pattern, etching the silicon substrate based on the predetermined pattern to form an etched portion of the silicon substrate, removing a third portion of the photoresist layer to thereby form an exposed portion of the silicon substrate, and depositing calcite on the etched and exposed portions of the silicon substrate.

Embodiment 5: A device comprising a silicon substrate, a calcite layer formed on the silicon substrate and having fluid channels for entrainment of fluid therein, and first and second electrodes for introducing electrical potential across the fluid channels and for analyzing electrical characteristics as a function of the electrical potential due to entrainment of fluid in the fluid channels.

Embodiment 6: The device of embodiment 5, further comprising an observation window for observing an effect of the electrical potential on the fluid and/or channels.

Embodiment 7: The device of embodiments 5 or 6, further comprising inlet and outlet ports in communication with the fluid channels.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method for demonstrating the efficacy of using electrical current in an Electrical Improved Oil Recovery (EIOR) application, comprising:
circulating fluid through a microfluidics cell having first and second electrodes;
applying a voltage across the first and second electrodes;
determining the behavior of the fluid under the effect of the applied voltage; and
correlating the determined behavior to a reservoir of interest.

2. The method of claim 1, further comprising deriving operational parameters from the correlation and operating the reservoir of interest in accordance with the operational parameters.

3. The method of claim 1, further comprising visualization and characterization of enlarging pore throat for enhancing permeability and oil mobilization.

4. A method for fabricating a microfluidics cell comprising:
applying a photoresist layer on a silicon substrate;
removing a first portion of the photoresist layer;
applying a pair of electrodes at the removed first portion;
removing a second portion of the photoresist to form a predetermined pattern;
etching the silicon substrate based on the predetermined pattern to form an etched portion of the silicon substrate;
removing a third portion of the photoresist layer to thereby form an exposed portion of the silicon substrate; and
depositing calcite on the etched and exposed portions of the silicon substrate.

5. A device comprising:
a silicon substrate;
a calcite layer formed on the silicon substrate and having fluid channels for entrainment of fluid therein; and
first and second electrodes for introducing electrical potential across the fluid channels and for analyzing electrical characteristics as a function of the electrical potential due to entrainment of fluid in the fluid channels.

6. The device of claim 5, further comprising:
an observation window for observing an effect of the electrical potential on the fluid and/or channels.

7. The device of claim 5, further comprising:
inlet and outlet ports in communication with the fluid channels.
